(19) United States
(12) Patent Application Publication
(10) Pub. No.: US 2024/0017720 A1
(43) Pub. Date: Jan. 18, 2024

(54) SYSTEM AND METHOD FOR CONTROLLING A VEHICLE SYSTEM

(71) Applicant: Toyota Motor Engineering & Manufacturing North America, Inc., Plano, TX (US)

(72) Inventors: Miles J. Johnson, Ann Arbor (US); Paul Timothy Fanson, Howell, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 17/862,874

(22) Filed: Jul. 12, 2022

(51) Int. Cl. B60W 30/09; B60W 30/165

(52) U.S. Cl. CPC B60W 30/09; B60W 30/165; B60W 2530/10; B60W 2530/201; B60W 2530/20; B60W 2510/20; B60W 2300/14

(57) ABSTRACT

A system includes a processor and a memory in communication with the processor that includes a path planning module. The path planning module causes the processor to determine a nominal driving path for a leading vehicle and a following vehicle that follows the leading vehicle and identify an obstacle in an external environment that prevents one of the leading vehicle and the following vehicle from utilizing the nominal driving path. In response to identifying the obstacle, the path planning module causes the processor to determine an alternate driving path for one of the leading vehicle and the following vehicle that avoids the obstacle and operate the leading vehicle and the following vehicle such that one of the leading vehicle and the following vehicle that is prevented from utilizing the nominal driving path due to the obstacle utilizes the alternate driving path and the other utilizes the nominal driving path.

### TECHNICAL FIELD

The subject matter described herein relates, in general, to systems and methods for controlling a leading vehicle and a following vehicle that follows the leading vehicle.

### BACKGROUND

The background description provided is to present the context of the disclosure generally. Work of the inventors, to the extent it may be described in this background section, and aspects of the description that may not otherwise qualify as prior art at the time of filing, are neither expressly nor impliedly admitted as prior art against the present technology.

Some current vehicles can tow another object, such as a trailer. In one example, the trailer is unpowered and therefore must be physically connected to a towing vehicle that effectively provides the power that tows the trailer. The towing vehicle should have the appropriate capabilities that allow for towing of the trailer. As such, if the trailer is fairly heavy, the towing vehicle must have the appropriate towing range to safely tow the vehicle.

Additionally, some have semi-autonomous and/or autonomous modes. Regarding a semi-autonomous mode, the vehicle may provide features that allow the vehicle to assist the driver in preventing or minimizing accidental collisions with other vehicles, pedestrians, or other objects. Vehicles that have an autonomous mode take this concept even further. In an autonomous mode, the vehicle is in complete control of the driving, without input from the driver. These autonomous and/or autonomous modes may additionally have modifications that assist with safely towing the trailer.

### SUMMARY

This section generally summarizes the disclosure and is not a comprehensive explanation of its full scope or all its features.

In one embodiment, a system includes a processor and a memory in communication with the processor. The memory includes a path planning module including instructions that, when executed by the processor, cause the processor to determine a nominal driving path for a leading vehicle and a following vehicle that follows the leading vehicle, identify an obstacle in an external environment that prevents one of the leading vehicle and the following vehicle from utilizing the nominal driving path, and in response to identifying the obstacle, determine an alternate driving path for one of the leading vehicle and the following vehicle that avoids the obstacle. Once this occurs, the processor may then operate the leading vehicle and the following vehicle such that the one of the leading vehicle and the following vehicle that is prevented from utilizing the nominal driving path due to the obstacle utilizes the alternate driving path and the other utilizes the nominal driving path.

In another embodiment, a method includes the step of determining a nominal driving path for a leading vehicle and a following vehicle that follows the leading vehicle. The method also includes identifying, using sensor data from a sensor system, an obstacle in an external environment that prevents one of the leading vehicle and the following vehicle from utilizing the nominal driving path. In response to identifying the obstacle, the method further includes determining an alternate driving path for one of the leading vehicle and the following vehicle that avoids the obstacle. The method further includes operating the leading vehicle and the following vehicle such that one of the leading vehicle and the following vehicle that is prevented from utilizing the nominal driving path due to the obstacle utilizes the alternate driving path and the other utilizes the nominal driving path.

In yet another embodiment, a non-transitory computer-readable medium includes instructions that, when executed by a processor, cause the processor to determine a nominal driving path for a leading vehicle and a following vehicle that follows the leading vehicle, identify an obstacle in an external environment that prevents one of the leading vehicle and the following vehicle from utilizing the nominal driving path; in response to identifying the obstacle, determine an alternate driving path for one of the leading vehicle and the following vehicle that avoids the obstacle. The instructions may then cause the processor to operate the leading vehicle and the following vehicle such that one of the leading vehicle and the following vehicle that is prevented from utilizing the nominal driving path due to the obstacle utilizes the alternate driving path and the other utilizes the nominal driving path.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1A illustrates an example of a leading vehicle and a following vehicle that follows the leading vehicle and that is not physically connected to the leading vehicle;

FIG. 1B illustrates an example of a leading vehicle and a following vehicle that follows the leading vehicle and that is physically connected to the leading vehicle;

FIG. 2A illustrates one embodiment of a vehicle within which systems and methods disclosed herein may be implemented;

FIG. 2B illustrates an example of a path planning system that is associated with controlling the leading vehicle and/or the following vehicle;

FIG. 3A illustrates one example of operating the leading vehicle and the following vehicle to utilize a nominal driving path;

FIG. 3B illustrates one example of operating the leading vehicle to utilize the nominal driving path and operating the following vehicle to utilize an alternate driving path to avoid an obstacle in the nominal driving path that prevents the following vehicle from utilizing the nominal driving path;

FIG. 3C illustrates the example shown in FIG. 3B showing the alternate driving path merging with the nominal driving path after the leading vehicle and/or the following vehicle pass the obstacle; and

FIG. 4 illustrates a method of operating the leading vehicle and the following vehicle.

### DETAILED DESCRIPTION

Described is a system and method for controlling a vehicle system including a leading vehicle and a following vehicle that follows the leading vehicle. The vehicle system is configured to determine a nominal driving path and identify an obstacle in the nominal driving path that prevents the leading vehicle and/or the following vehicle from utilizing the nominal driving path. The vehicle system can determine an alternate driving path for the leading vehicle and/or the following vehicle that avoids the obstacle and operate the leading vehicle and/or the following vehicle to utilize the alternate driving path.

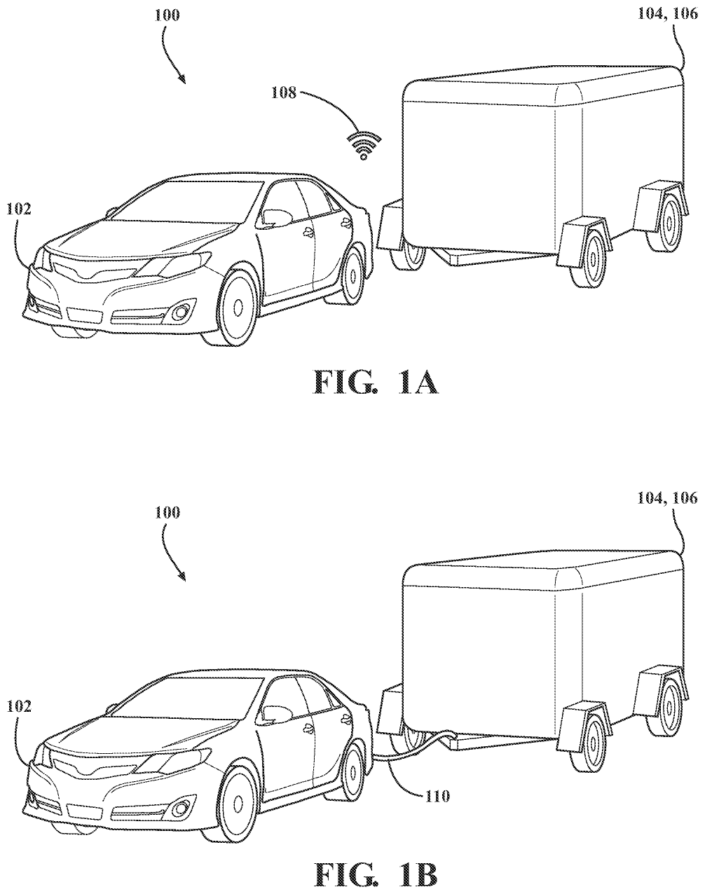

Referring to FIGS. 1A and 1B, an example of a vehicle system 100 is illustrated. The vehicle system 100 includes a leading vehicle 102 and a following vehicle 104. As used herein, a “vehicle” is any form of powered transport. In one example, the leading vehicle 102 is an automobile and/or while the following vehicle 104 is a hitchless trailer. While arrangements will be described herein with respect to automobiles and hitchless trailers, it will be understood that embodiments are not limited to automobiles and hitchless trailers. In some implementations, the leading vehicle 102 and/or the following vehicle 104 may be any robotic device or form of powered transport that, for example, includes one or more automated or autonomous systems, and thus benefits from the functionality discussed herein.

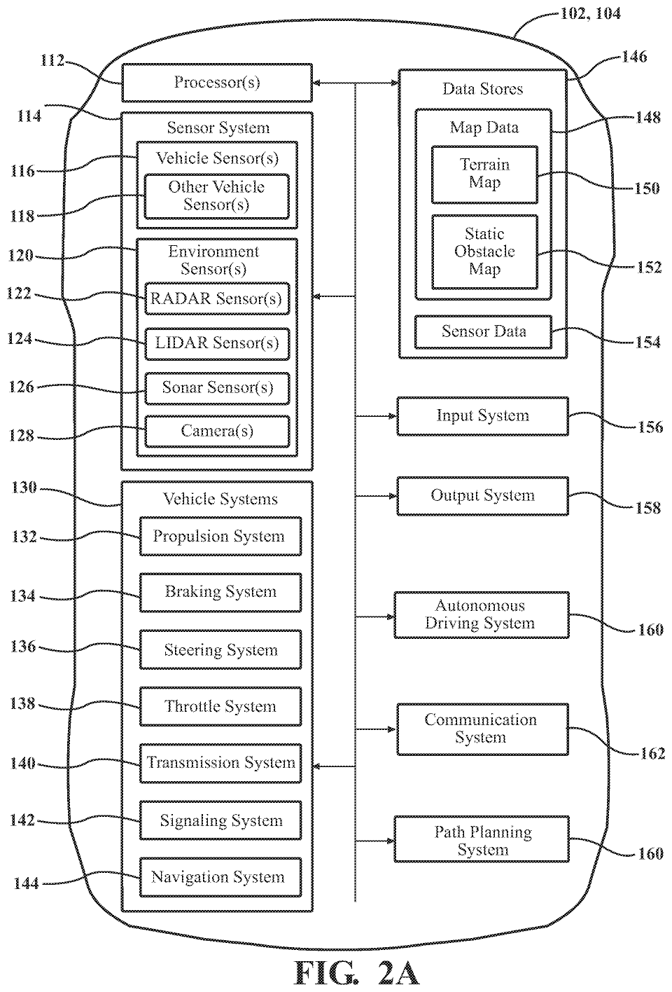

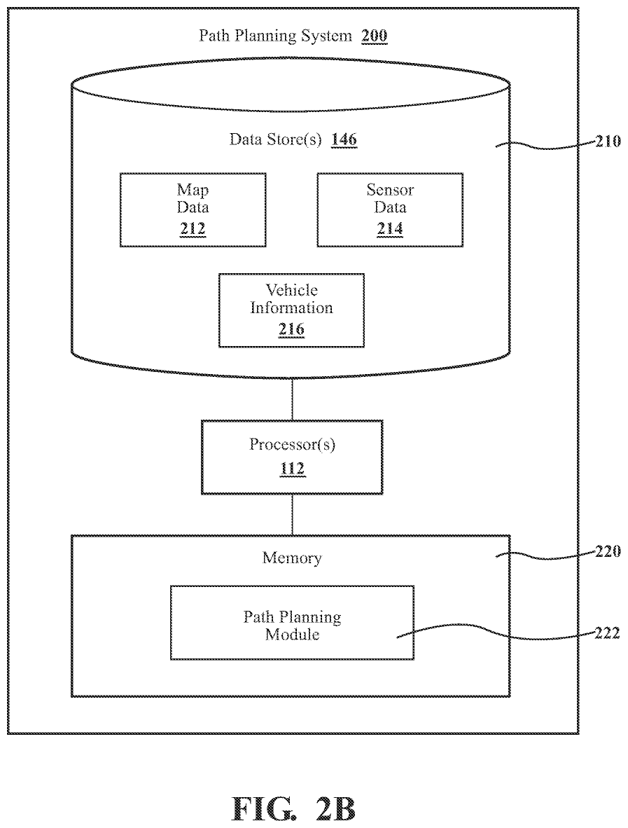

In various embodiments, the automated/autonomous systems or combination of systems may vary. For example, in one aspect, the automated system may provide autonomous control of the vehicle according to one or more levels of automation such as the levels defined by the Society of Automotive Engineers (SAE) (e.g., levels 0-5). As such, the autonomous system may provide semi-autonomous control or fully autonomous control as discussed in relation to an autonomous driving system 160 (discussed in further detail below with reference to FIG. 2A).

The leading vehicle 102 and/or the following vehicle 104 can be any suitable type of vehicle. For example, the leading vehicle 102 and/or the following vehicle 104 can be a pick-up truck, an SUV, a motorhome, a motorcycle, or any other type of vehicle. In one or more arrangements, the following vehicle 104 can be a camper, a boat trailer, etc., and can be an unmanned vehicle (e.g., a vehicle configured to be operated without a human operator). The leading vehicle 102 and the following vehicle 104 can be the same type of vehicle or the leading vehicle 102 and the following vehicle 104 can be different types of vehicles.

As shown, the leading vehicle 102 is a sedan and the following vehicle 104 is a hitchless trailer 106. The hitchless trailer 106 can include various systems (discussed in further detail below with reference to FIG. 2A) configured to propel and/or brake the hitchless trailer 106 independent of the leading vehicle 102, for example, by not being physically connected to the leading vehicle 102 by a load-bearing connection. In one or more arrangements, with specific reference to FIG. 1A, the hitchless trailer 106 is communicatively connected to the leading vehicle 102 by a wireless communication network 108. In other examples, with specific reference to FIG. 1B, the hitchless trailer 106 is communicatively connected to the leading vehicle 102 by a wired communication network 110. The use of a hitchless trailer has certain advantages in that it does not require that the towing vehicle be physically connected to the hitchless trailer and further does not require that the towing vehicle have the appropriate capabilities for physically towing the hitchless trailer, as the hitchless trailer provides the power to move itself.

The vehicle system 100 can be configured for any type of driving activities. For example, the vehicle system 100 can be configured for driving on surface streets and/or highways. More specifically, the vehicle system 100 can be configured for off-roading driving, for example, driving through uneven terrain, campsites, mountains, etc.

Referring now to FIG. 2A, the leading vehicle 102 and/or the following vehicle 104 can include various elements. It will be understood that in various embodiments it may not be necessary for the leading vehicle 102 and/or the following vehicle 104 to have all of the elements shown in FIG. 2A. The leading vehicle 102 and/or the following vehicle 104 can have any combination of the various elements shown in FIG. 2A. Further, the leading vehicle 102 and/or the following vehicle 104 can have additional elements to those shown in FIG. 2A. In some arrangements, the leading vehicle 102 and/or the following vehicle 104 may be implemented without one or more of the elements shown in FIG. 2A. While the various elements are shown as being located within the leading vehicle 102 and/or the following vehicle 104 in FIG. 2A, it will be understood that one or more of these elements can be located external to the leading vehicle 102 and/or the following vehicle 104. Further, the elements shown may be physically separated by large distances and provided as remote services (e.g., cloud-computing services).

Some of the possible elements of the leading vehicle 102 and/or the following vehicle 104 are shown in FIG. 2A and will now be described along with subsequent figures. However, a description of many of the elements in FIG. 2A will be provided after the discussion of FIGS. 2B-4 for purposes of brevity of this description. It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. It should be understood that the embodiments described herein may be practiced using various combinations of these elements.

In either case, the leading vehicle 102 and/or the following vehicle 104 includes a path planning system 200. The path planning system 200 may be incorporated within an autonomous driving system 160 or may be separate as shown. Broadly, the path planning system 200 may determine a nominal driving path and identify an obstacle in the nominal driving path that prevents the leading vehicle 102 and/or the following vehicle 104 from utilizing the nominal driving path. The path planning system 200 can determine an alternate driving path for the leading vehicle 102 and/or the following vehicle 104 that avoids the obstacle and operate the leading vehicle 102 and/or the following vehicle 104 to utilize the alternate driving path.

One embodiment of the path planning system 200 is illustrated in FIG. 2B. As shown, the path planning system 200 includes one or more data store(s) 210. The data store(s) 210 can be an electronic data structure such as a database that is stored in a memory 220 or another memory and that is configured with routines that can be executed by one or more processor(s) 112 for analyzing stored data, providing stored data, organizing stored data, and so on. Thus, in one embodiment, the data store(s) 210 stores data used by a path planning module 222 in executing various functions.

In one embodiment, the data store(s) 210 includes map data 212 and sensor data 214, along with, for example, other information that is used by the path planning module 222. For example, the data store(s) 210 can store vehicle information 216 and/or data about the leading vehicle 102 and/or the following vehicle 104. The vehicle information 216 can include, for example, a mass, a weight, a load, a height, a length, a width, wheel base dimensions, tire dimensions, tire pressure, ground clearance, tuning and/or calibration parameters, steering angle constraints, etc. of the leading vehicle 102 and/or the following vehicle 104. The sensor data 214 may include some or all of the sensor data 154 shown in FIG. 2A and/or collected by any of the sensors forming the sensor system 114 and described later in this disclosure.

The path planning system 200 also includes a processor(s) 112. The processor(s) 112 may be a part of the path planning system 200 or the path planning system 200 may access the processor(s) 112 through a data bus or another communication path. In general, the processor(s) 112 is an electronic processor such as a microprocessor that is capable of performing various functions as described herein. In one embodiment, the path planning system 200 includes the memory 220 (mentioned above) that stores the path planning module 222. The memory 220 is a random-access memory (RAM), read-only memory (ROM), a hard disk drive, a flash memory, or other suitable memory for storing the path planning module 222. The path planning module 222 includes, for example, computer-readable instructions that when executed by the processor(s) 112 cause the processor(s) 112 to perform the various functions disclosed herein.

As mentioned above, the leading vehicle 102 and/or the following vehicle 104 can also include a path planning module 222. The path planning module 222 can receive data and/or information from the autonomous driving system 160 (and/or can work in conjunction with the autonomous driving system 160) as well as receive data and/or information from the processor(s) 112, the sensor system 114, the vehicle systems 130, the data store(s) 146, and/or the input system 156 to determine a driving path for the leading vehicle 102 and/or the following vehicle 104. More specifically, the path planning module 222 is configured to determine a nominal driving path for the leading vehicle 102 and/or the following vehicle 104. The nominal driving path can be the main driving path that the leading vehicle 102 and/or the following vehicle 104 utilize. For example, the nominal driving path can be the fastest and/or the safest path to the destination (e.g. predetermined location) inputted into the input system 156 by a passenger of the leading vehicle 102 and/or the following vehicle 104. The autonomous driving system 160 can operate the leading vehicle 102 and/or the following vehicle 104 to utilize the nominal driving path.

The path planning module 222 can also, using data and/or information form the autonomous driving system 160 (or in conjunction with the autonomous driving system 160) as well as data and/or information from the processor(s) 112, the sensor system 114, the vehicle systems 130, the data store(s) 146, and the input system 156, identify one or more obstacles in the external environment of the leading vehicle 102 and/or the following vehicle 104 that obstruct the nominal driving path. For example, in off-roading driving scenarios, the path planning module 222 can identify large rocks, fallen trees, creeks and rivers, muddy areas, low-hanging tree branches, etc. In other words, the path planning module 222 can be configured to identify an obstacle in the nominal driving path and determine the ability of the leading vehicle 102 and/or the following vehicle 104 to traverse (e.g., drive over, under, or around) the obstacle. This may be done with the use of the vehicle information 216.

If the path planning module 222 identifies an obstacle in the nominal driving path that the leading vehicle 102 and/or the following vehicle 104 cannot traverse, the path planning module 222 is then configured to determine an alternate driving path. The alternate driving path is a driving path that avoids the obstacle in the nominal driving path. In some arrangements, the alternate driving path diverges from the nominal driving path by a few feet. In some arrangements, the alternate driving path diverges from the nominal driving path by 10 or more feet. However, in some arrangements, the alternate driving path remains close enough to the nominal driving path such that the leading vehicle 102 and/or the following vehicle 104, and the elements thereof, remain in communication with each other (e.g., through the wireless communication network 108 or the wired communication network 110). Based on the ability of the leading vehicle 102 and/or the following vehicle 104 to traverse the object in the nominal driving path, the autonomous driving system 160 can be configured to operate the leading vehicle 102 or the following vehicle 104 to utilize the alternate driving path.

For example, if the leading vehicle 102 is able to traverse the object while the following vehicle 104 is unable to traverse the object, the autonomous driving system 160 can be configured to operate the leading vehicle 102 to utilize the nominal driving path and operate the following vehicle 104 to utilize the alternate driving path. If the leading vehicle 102 is unable to traverse the object while the following vehicle 104 is able to traverse the object, the autonomous driving system 160 can be configured to operate the leading vehicle 102 to utilize the alternate driving path and operate the following vehicle 104 to utilize the nominal driving path. If both the leading vehicle 102 and the following vehicle 104 are able to traverse the object, the autonomous driving system 160 can be configured to operate both the leading vehicle 102 and the following vehicle 104 to utilize the nominal driving path.

After both the leading vehicle 102 and the following vehicle 104 have traveled past the object (e.g. by utilizing the nominal driving path and traversing the object or by utilizing the alternate driving path and avoiding the object), the alternate driving path can be configured to merge with the nominal driving path such that the leading vehicle 102 and the following vehicle 104 are both operated to utilize the nominal driving path again.

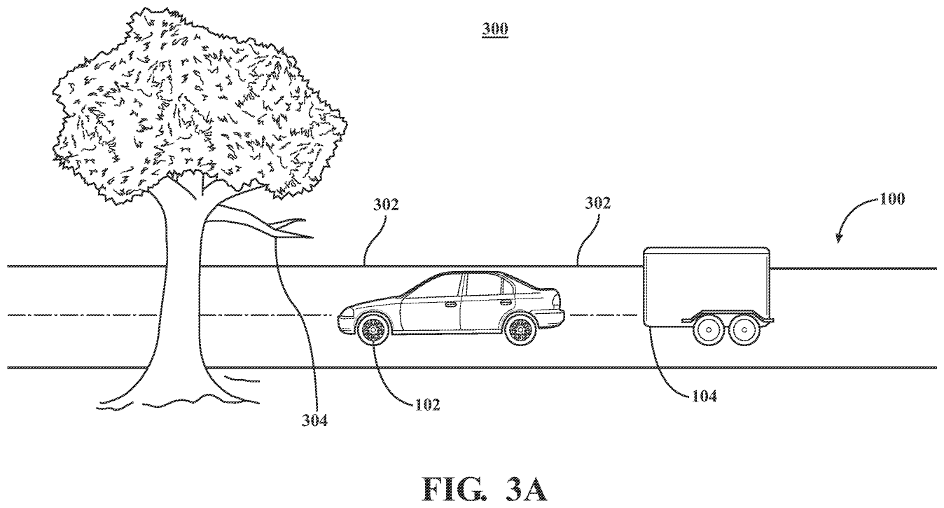

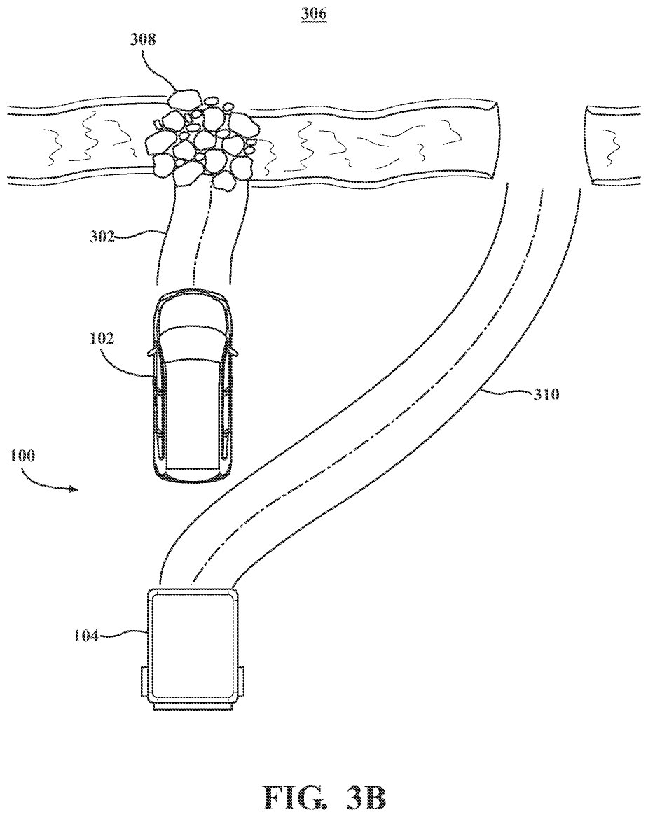

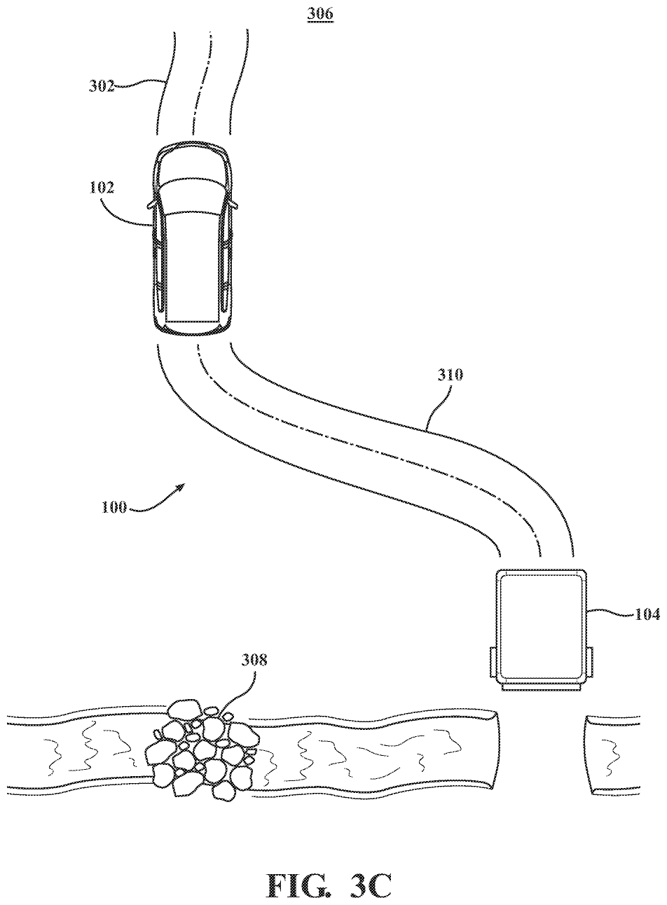

Referring now to FIG. 3A, an example of a first driving scenario 300 is shown. In the first driving scenario 300, the leading vehicle 102 and/or the following vehicle 104 are utilizing the nominal driving path 302 and approaching an obstacle 304, which is a low-hanging tree branch. The path planning module 222 can determine that the leading vehicle 102 and the following vehicle 104 are both able to traverse the obstacle 304 by driving under it. Accordingly, the autonomous driving system 160 can be configured to operate both the leading vehicle 102 and the following vehicle 104 to continue utilizing the nominal driving path 302 to drive under the obstacle 304.

With reference now to FIGS. 3B and 3C, an example of a second driving scenario 306 is shown. In the second driving scenario 306, as shown in FIG. 3B, the leading vehicle 102 and the following vehicle 104 are approaching an obstacle 308, which is an area with rocks and water (e.g. a creek or stream). The path planning module 222 may determine that the leading vehicle 102 is able to traverse the obstacle 308 by driving over it (e.g., if the leading vehicle 102 is an SUV with 4-wheel drive). The path planning module 222 may determine that the following vehicle 104 is unable to traverse the obstacle 308 (e.g., if the following vehicle 104 is a trailer with a high center of gravity that might tip over if driven across the obstacle 308). Accordingly, the autonomous driving system 160 can be configured to operate the leading vehicle 102 to utilize the nominal driving path 302 and operate the following vehicle 104 to utilize the alternate driving path 310.

The path planning module 222 may receive information and/or data that indicates there is a flat portion of terrain ahead of the following vehicle 104 and can determine that the alternate driving path 310 can traverse that portion of the terrain. As shown in FIG. 3C, after the leading vehicle 102 and the following vehicle 104 travel past the obstacle 308, the alternate driving path 310 merges with the nominal driving path 302 such that the following vehicle 104 is following the leading vehicle 102 again. The autonomous driving system 160 can operate the leading vehicle 102 to continue following the nominal driving path 302 and can operate the following vehicle 104 to follow the alternate driving path 310 that merges with the nominal driving path 302. The distances between the nominal driving path 302 and the alternate driving path 310 may vary considerably from application to application. However, in one example, the furthest distance between the nominal driving path 302 and the alternate driving path 310 may be approximately 100 meters or less.

In some arrangements, the leading vehicle 102 and/or the following vehicle 104 can be configured to display driving scenarios similar to those depicted in FIGS. 3A-3C to one or more passengers of the leading vehicle 102 and/or the following vehicle 104 using the output system 158. For example, the output system 158 may display graphical depictions of the nominal driving path 302 and the alternate driving path 310 to inform passengers of the driving paths utilized by the leading vehicle 102 and/or the following vehicle 104.

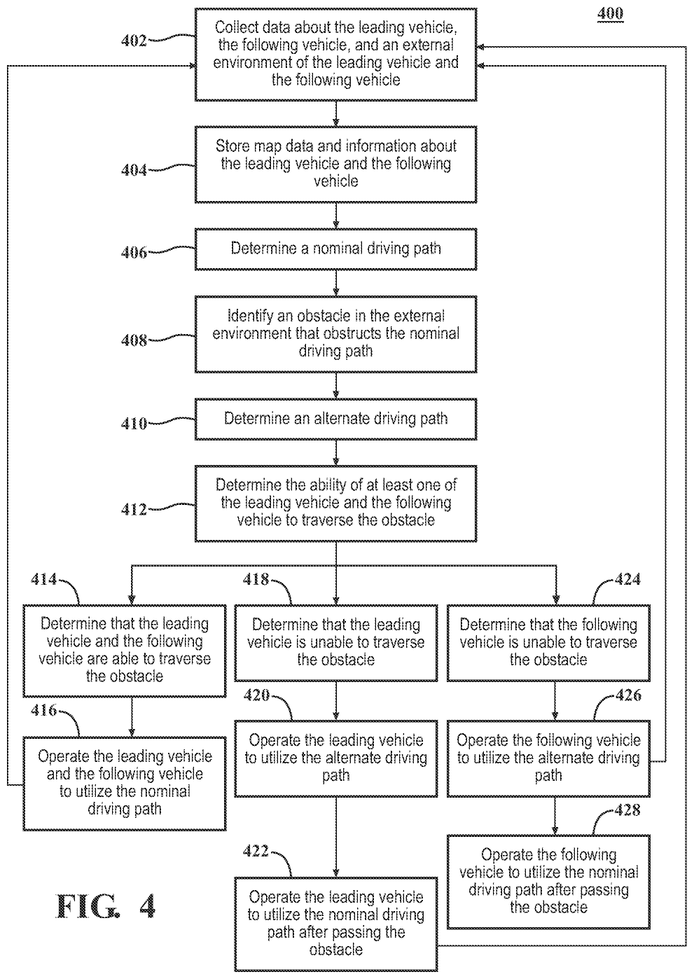

Referring now to FIG. 4, an example of a method 400 for the vehicle system 100 is shown. The method 400 will be described from the viewpoint of the vehicle 102 or 104 of FIG. 2A and the path planning system 200 of FIG. 2B. However, it should be understood that this is just one example of implementing the method 400. While the method 400 is discussed in combination with the path planning system 200, it should be appreciated that the method 400 is not limited to being implemented within the path planning system 200, but is instead one example of a system that may implement the method 400.

The method 400 begins at step 402, wherein instructions stored within the path planning module 222, when are executed by the processor(s) 112, cause the processor(s) 112 to collect data about the leading vehicle 102, the following vehicle 104, and an external environment of the leading vehicle 102. In one example, the processor(s) 112 may receive data from the sensor system 114 of the vehicle system 100.

In step 404, instructions within the path planning module 222, when executed by the processor(s) 112, cause the processor(s) 112 to store map data and information about the leading vehicle 102 and the following vehicle 104. In one example, the processor(s) 112 may store this information within the data store(s) 210.

In step 406, instructions within the path planning module 222, when executed by the processor(s) 112, cause the processor(s) 112 to determine a nominal driving path, for example, based on the data collected in step 402 and the map data and information stored in step 404. The nominal driving path may be, in one example, a driving path for both the leading vehicle 102 in the following vehicle 104. However, as will be explained when describing later steps in the method 400, the nominal driving path may be such that only one of the vehicles 102 and/or 104 can utilize based on the presence of one or more obstacles.

In step 408, instructions within the path planning module 222, when executed by the processor(s) 112, cause the processor(s) 112 to identify an obstacle in the external environment that obstructs the nominal driving path. This identification of an obstacle can be performed by utilizing information from a map, such as one or more terrain map(s) 150 and/or information from the sensor system 114 and/or other information stored elsewhere, such as within the data store(s) 210. For example, in off-roading driving scenarios, the path planning system 200 can identify large rocks, fallen trees, creeks and rivers, muddy areas, low-hanging tree branches, etc. In other words, the path planning system 200 can be configured to identify an obstacle in the nominal driving path.

In step 410, instructions within the path planning module 222, when executed by the processor(s) 112, cause the processor(s) 112 to determine an alternate driving path, which can be, for example, a path that avoids the obstacle. For example, the alternate driving path may be such that diverges away from the nominal driving path for a period of time such that it avoids the obstacle. In one example, the alternate driving path may then merge with the nominal driving path after the obstacle has been passed. The alternate driving path may be an alternative portion of a road or nearby landscape that allows avoidance of the obstacle.

In step 412, instructions within the path planning module 222, when executed by the processor(s) 112, cause the processor(s) 112 to determine the ability of the leading vehicle 102 and/or the following vehicle 104 to traverse (e.g., drive over, under, or around) the obstacle. This may be done with the use of the vehicle information 216. For example, using the vehicle information 216, which can include a mass, a weight, a load, a height, a length, a width, wheel base dimensions, tire dimensions, tire pressure, ground clearance, tuning and/or calibration parameters, steering angle constraints, etc. of the leading vehicle 102 and/or the following vehicle 104 as well as information regarding the obstacle, such as the type of obstacle, dimensions of the obstacle, location of the obstacle, the processor(s) 112 to determine if the obstacle will prevent the leading vehicle 102 and/or the following vehicle 104 from traversing the nominal driving path. The preventing of traversing the nominal driving path may be determined in situations where in the obstacle comes into contact with the undercarriage or one or more body panels of the vehicle and/or situations that may result in an increased probability of damage to the leading vehicle 102 and/or the following vehicle 104 and/or causing potential harm or damage to the contents or passengers of the leading vehicle 102 and/or the following vehicle 104.

It should be noted that steps 410 and 412 may be reversed or depend upon one another. For example, when calculating the alternate driving path, the ability of the leading vehicle 102 and/or the following vehicle 104 may be considered so as to generate an alternate driving path that one or both vehicles can utilize in the invent that is determined that the obstacle should be avoided by one of those vehicles.

Based on the determination performed in step 412, the method 400 may execute different sets of steps based on the situation. For example, if the path planning module 222 causes the processor(s) 112 to determine that the leading vehicle 102 and the following vehicle 104 are able to traverse the obstacle, the processor(s) 112 may then operate the leading vehicle 102 and the following vehicle 104 to utilize the nominal driving path, as shown in steps 414 and 416.

However, if the path planning module 222 causes the processor(s) 112 to determine that the leading vehicle 102 is unable to traverse the obstacle, the processor(s) 112 may then operate the leading vehicle 102 to utilize the alternate driving path and then operate the following vehicle 104 to utilize the nominal driving path after passing the obstacle, as shown in steps 418, 420, and 422. Essentially, a determination was made that the leading vehicle 102 is unable to traverse the obstacle, therefore, the leading vehicle 102 will utilize the alternate driving path for at least a period of time until the obstacle has been passed.

In another situation, if the path planning module 222 causes the processor(s) 112 to determine that the following vehicle 104 is unable to traverse the obstacle, the path planning module 222 may cause the processor(s) 112 to operate the following vehicle 104 to utilize the alternate driving path until the obstacle is passed and then operate the following vehicle to utilize the nominal driving path, as shown in steps 424, 426, and 428.

As such, depending on the determination regarding if the leading vehicle 102 and/or the following vehicle 104 can safely traverse the obstacle, the method 400 may result in at least one of the following four scenarios:
(a) both the leading vehicle 102 and the following vehicle 104 utilize the nominal driving path when both the leading vehicle 102 and the following vehicle 104 can safely traverse the obstacle;
(b) the leading vehicle 102 utilizes the alternate driving path while the following vehicle 104 utilizes the nominal driving path when the following vehicle 104 can safely traverse the obstacle but the leading vehicle 102 cannot safely traverse the obstacle;
(c) the following vehicle 104 utilizes the alternate driving path while the leading vehicle 102 utilizes the nominal driving path when the leading vehicle 102 can safely traverse the obstacle but the following vehicle 104 cannot safely traverse the obstacle; and
(d) both the leading vehicle 102 and the following vehicle 104 utilize the alternate driving path when neither the leading vehicle 102 nor the following vehicle 104 can safely traverse the obstacle.

FIG. 2A will now be discussed in full detail as an example environment within which the system and methods disclosed herein may operate. In one or more embodiments, the leading vehicle 102 and/or the following vehicle 104 may be is an autonomous vehicle and/or semi-autonomous vehicle. As used herein, “autonomous vehicle” refers to a vehicle that operates in an autonomous mode. “Autonomous mode” refers to navigating and/or maneuvering the leading vehicle 102 and/or the following vehicle 104 along a travel route using one or more computing systems to control the leading vehicle 102 and/or the following vehicle 104 with minimal or no input from a human driver. In one or more embodiments, the leading vehicle 102 and/or the following vehicle 104 are highly automated or completely automated. In one embodiment, the leading vehicle 102 and/or the following vehicle 104 are configured with one or more semi-autonomous operational modes in which one or more computing systems perform a portion of the navigation and/or maneuvering of the leading vehicle 102 and/or the following vehicle 104 along a travel route, and a vehicle operator (i.e., driver) provides inputs to the vehicle to perform a portion of the navigation and/or maneuvering of the leading vehicle 102 and/or the following vehicle 104 along a travel route.

The leading vehicle 102 and/or the following vehicle 104 can include one or more processor(s) 112. In one or more arrangements, the processor(s) 112 can be one or more main processors (e.g., one or more electronic control units (ECUs)) of the leading vehicle 102 and/or the following vehicle 104.

As mentioned before, the leading vehicle 102 and/or the following vehicle 104 can also include a sensor system 114. The sensor system 114 can include one or more sensors. “Sensor” means any device, component and/or system that can detect, and/or sense something. The one or more sensors can be configured to detect and/or sense in real-time. As used herein, the term “real-time” means a level of processing responsiveness that a user or system senses as sufficiently immediate for a particular process or determination to be made, or that enables the processor(s) 112 to keep up with some external process.

In arrangements in which the sensor system 114 includes a plurality of sensors, the sensors can work independently from each other. Alternatively, two or more of the sensors can work in combination with each other. In such a case, the two or more sensors can form a sensor network. The sensor system 114 and/or the one or more sensors can be operatively connected to the processor(s) 112, one or more data store(s) 146 (described in further detail below), and/or another element or other elements of the leading vehicle 102 and/or the following vehicle 104 (including any of the elements shown in FIG. 2A).

The sensor system 114 can include any suitable type of sensors. Various examples of different types of sensors will be described herein. However, it will be understood that the embodiments are not limited to the particular sensors described. The sensor system 114 can include one or more vehicle sensor(s) 116. The vehicle sensor(s) 116 can detect, determine, and/or sense information about the leading vehicle 102 and/or the following vehicle 104. In one or more arrangements, the vehicle sensor(s) 116 can be configured to detect and/or sense position and orientation changes of the leading vehicle 102 and/or the following vehicle 104, for example, based on inertial acceleration. In one or more arrangements, the vehicle sensor(s) 116 can include one or more accelerometers, one or more gyroscopes, one or more inertial measurement units (IMUs), one or more dead-reckoning systems, one or more global navigation satellite systems (GNSSs), one or more global positioning systems (GPSs), one or more navigation systems 144 (described in further detail below), and/or other suitable sensors. The vehicle sensor(s) 116 can be configured to detect and/or sense one or more characteristics of the leading vehicle 102 and/or the following vehicle 104. In one or more arrangements, the vehicle sensor(s) 116 can include one or more speedometers to determine a current speed of the leading vehicle 102 and/or the following vehicle 104. The vehicle sensor(s) 116 can include other vehicle sensor(s) 118 not specifically described herein. For example, the vehicle sensor(s) 116 can include one or more steering angle sensors, one or more pedal position sensors, one or more throttle position sensors, one or more wheel alignment sensors, one or more wheel slip sensors, etc.

Additionally or alternatively, the sensor system 114 can include one or more environment sensor(s) 120 configured to acquire and/or sense driving environment data. “Driving environment data” includes data or information about the external environment in which the leading vehicle 102 and/or the following vehicle 104 are located or one or more portions thereof. For example, the environment sensor(s) 120 can be configured to detect, quantify, and/or sense obstacles in at least a portion of the external environment of the leading vehicle 102 and/or the following vehicle 104 and/or information and/or data about such obstacles. Such obstacles may be stationary objects and/or dynamic objects. The environment sensor(s) 120 can be configured to detect, measure, quantify, and/or sense other things in the external environment of the leading vehicle 102 and/or the following vehicle 104, such as lane markers, signs, traffic lights, traffic signs, lane lines, crosswalks, curbs, off-road objects such as rocks, streams and rivers, low-hanging tree branches, etc.

The environment sensor(s) 120 can include any suitable sensors. For example, the environment sensor(s) 120 can include one or more radar sensors 122, one or more LIDAR sensors 124, one or more sonar sensors 126, and/or one or more cameras 128. In one or more arrangements, the one or more cameras 128 can be high dynamic range (HDR) cameras or infrared (IR) cameras. Though not shown in FIG. 2A, the environment sensor(s) 120 can additionally or alternatively include one or more Doppler sensors, one or more temperature sensors, one or more sound sensors, and/or any other type of sensors.

In one or more arrangements, one or more of the environment sensor(s) 120 can be located on the leading vehicle 102 and can be configured to collect data about the following vehicle 104. For example, environment sensors(s) 120 located on the leading vehicle 102 can be configured to collect data about the location, orientation, speed, etc. of the following vehicle 104. Similarly, one or more of the environment sensor(s) 120 can be located on the following vehicle 104 and can be configured to collect data about the leading vehicle 102. For example, environment sensors(s) 120 located on the following vehicle 104 can be configured to collect data about the location, orientation, speed, etc. of the leading vehicle 102.

With continued reference to FIG. 2A, the leading vehicle 102 and/or the following vehicle 104 can include one or more vehicle systems 130. It should be appreciated that although particular vehicle systems are separately defined, each or any of the systems or portions thereof may be otherwise combined or segregated via hardware and/or software within the leading vehicle 102 and/or the following vehicle 104. The leading vehicle 102 and/or the following vehicle 104 can include a propulsion system 132, a braking system 134, a steering system 136, a throttle system 138, a transmission system 140, a signaling system 142, and/or a navigation system 144. Each of these systems can include one or more devices, components, and/or a combination thereof, now known or later developed.

The navigation system 144 can include one or more devices, applications, and/or combinations thereof, now known or later developed, configured to determine the geographic location of the leading vehicle 102 and/or the following vehicle 104. The navigation system 144 can include a global positioning system, a local positioning system or a geolocation system.

The leading vehicle 102 and/or the following vehicle 104 can also include one or more data store(s) 146 for storing one or more types of data. The data store(s) 146 can include volatile and/or non-volatile memory. Examples of suitable data store(s) include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 146 can be a component of the processor(s) 112, or the data store(s) 146 can be operatively connected to the processor(s) 112 for use thereby. The term “operatively connected,” as used throughout this description, can include direct or indirect connections, including connections without direct physical contact.

In one or more arrangements, the data store(s) 146 can include map data 148. The map data 148 can include maps of one or more geographic areas. In some instances, the map data 148 can include information or data on roads, traffic control devices, road markings, structures, features, and/or landmarks in the one or more geographic areas. The map data 148 can be in any suitable form. In some instances, the map data 148 can include aerial views of an area. In some instances, the map data 148 can include ground views of an area, including 360-degree ground views. The map data 148 can include measurements, dimensions, distances, and/or information for one or more items included in the map data 148 and/or relative to other items included in the map data 148. The map data 148 can include a digital map with information about road geometry. The map data 148 can be high quality and/or highly detailed.

In one or more arrangements, the map data 148 can include one or more terrain map(s) 150. The terrain map(s) 150 can include information about the ground, terrain, roads, surfaces, and/or other features of one or more geographic areas. The terrain map(s) 150 can include elevation data in the one or more geographic areas. The map data 148 can be high quality and/or highly detailed. The terrain map(s) 150 can define one or more ground surfaces, which can include paved roads, unpaved roads, land, and other things that define a ground surface.

In one or more arrangements, the map data 148 can include one or more static obstacle map(s) 152. The static obstacle map(s) 152 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, hills. The static obstacles can be objects that extend above ground level. The one or more static obstacles included in the static obstacle map(s) 152 can have location data, size data, dimension data, material data, and/or other data associated with it. The static obstacle map(s) 152 can include measurements, dimensions, distances, and/or information for one or more static obstacles. The static obstacle map(s) 152 can be high quality and/or highly detailed. The static obstacle map(s) 152 can be updated to reflect changes within a mapped area.

The data store(s) 146 can also include sensor data 154. In this context, “sensor data” means any information about the sensors that the leading vehicle 102 and/or the following vehicle 104 is equipped with, including the capabilities and other information about such sensors. The sensor data 154 can relate to one or more sensors of the sensor system 114.

In some instances, at least a portion of the map data 148 and/or the sensor data 154 can be located in one or more data store(s) 146 located onboard the leading vehicle 102 and/or the following vehicle 104. Additionally or alternatively, at least a portion of the map data 148 and/or the sensor data 154 can be located in one or more data store(s) 146 that are located remotely from the leading vehicle 102 and/or the following vehicle 104.

The leading vehicle 102 and/or the following vehicle 104 can also include an input system 156. An “input system” includes any device, component, system, element or arrangement or groups thereof that enable information/data to be entered into a machine. The input system 156 can receive an input from a vehicle passenger (e.g., a driver or a passenger). In some arrangements, the input can be a destination (e.g., a predetermined location) that a passenger of the leading vehicle 102 and/or the following vehicle 104 is traveling to. The leading vehicle 102 and/or the following vehicle 104 can also include an output system 158. An “output system” includes any device, component, or arrangement or groups thereof that enable information/data to be presented to a vehicle passenger (e.g., a person, a vehicle passenger, etc.).

The leading vehicle 102 and/or the following vehicle 104 can include an autonomous driving system 160, as mentioned and described above. The autonomous driving system 160 can be configured to receive data from the sensor system 114 and/or any other type of system capable of capturing information relating to the leading vehicle 102 and/or the following vehicle 104 and/or the external environment of the leading vehicle 102 and/or the following vehicle 104. In one or more arrangements, the autonomous driving system 160 can use such data to generate one or more driving scene models. The autonomous driving system 160 can determine position and velocity of the leading vehicle 102 and/or the following vehicle 104. The autonomous driving system 160 can determine the location of obstacles, obstacles, or other environmental features including traffic signs, trees, shrubs, neighboring vehicles, pedestrians, etc.

The autonomous driving system 160 can be configured to receive and/or determine location information for obstacles within the external environment of the leading vehicle 102 and/or the following vehicle 104 for use by the processor(s) described herein to estimate the position and orientation of the leading vehicle 102 and/or the following vehicle 104, vehicle position in global coordinates based on signals form a plurality of satellites, or any other data and/or signals that could be used to determine the current state of the leading vehicle 102 and/or the following vehicle 104 with respect to the environment for use in either creating a map or determining the position of the leading vehicle 102 and/or the following vehicle 104 in respect to map data.

The autonomous driving system 160, either independently or in combination with the path planning system 200, can be configured to determine one or more travel paths, current autonomous driving maneuvers for the leading vehicle 102 and/or the following vehicle 104, future autonomous driving maneuvers and/or modifications to current autonomous driving maneuvers based on data acquired by the sensor system 114, driving scene models, and/or data from any other suitable source such as determinations from the sensor data 154. “Driving maneuver” means one or more actions that affect the movement of a vehicle. Examples of driving maneuvers include: accelerating, decelerating, braking, turning, moving in a lateral direction of the leading vehicle 102 and/or the following vehicle 104, changing travel lanes, merging into a travel lane, and/or reversing, just to name a few possibilities. The autonomous driving system 160 can be configured to implement determined driving maneuvers. The autonomous driving system 160 can cause, directly or indirectly, such autonomous driving maneuvers to be implemented. As used herein, “cause” or “causing” means to make, command, instruct, and/or enable an event or action to occur or at least be in a state where such event or action may occur, either in a direct or indirect manner. The autonomous driving system 160 can be configured to execute various vehicle functions and/or transmit data to, receive data from, interact with, and/or control the leading vehicle 102 and/or the following vehicle 104 or one or more systems thereof (e.g., one or more of vehicle systems 130).

The processor(s) 112, the autonomous driving system 160, and/or the path planning system 200 can be operatively connected to communicate with the vehicle systems 130 and/or individual components thereof. For example, the processor(s) 112, the autonomous driving system 160, and/or the path planning system 200 can be in communication to send and/or receive information from the vehicle systems 130 to control the movement, speed, maneuvering, heading, direction, etc. of the leading vehicle 102 and/or the following vehicle 104. The processor(s) 112, the autonomous driving system 160, and/or the path planning system 200 may control some or all of these vehicle systems 130 and, thus, may be partially or fully autonomous.

The processor(s) 112, the autonomous driving system 160, and/or the path planning system 200 may be operable to control the navigation and/or maneuvering of the leading vehicle 102 and/or the following vehicle 104 by controlling one or more of the vehicle systems 130 and/or components thereof. For instance, when operating in an autonomous mode, the processor(s) 112, the autonomous driving system 160, and/or the path planning system 200 can control the direction and/or speed of the leading vehicle 102 and/or the following vehicle 104. The processor(s) 112, the autonomous driving system 160, and/or the path planning system 200 can cause the leading vehicle 102 and/or the following vehicle 104 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, direct, command, instruct, and/or enable an event or action to occur or at least be in a state where such event or action may occur, either in a direct or indirect manner.

The leading vehicle 102 and/or the following vehicle 104 can also include a communication system 162. The communication system 162 can be configured to communicatively connect the elements of the leading vehicle 102 and/or the following vehicle 104, including the processor(s) 112, the sensor system 1164, the vehicle systems 130, the data store(s) 146, the input system 156, the output system 158, the autonomous driving system 160, and/or the path planning system 200. In some arrangements, the communication system 162 can be configured to communicate information from the leading vehicle 102 to the following vehicle 104 and/or from the following vehicle 104 to the leading vehicle 102. The communication system can be implemented using a wireless network, Bluetooth, Wi-Fi Protected Access (WPA or WPA2), a mobile, cellular, and/or satellite-based wireless network, a wired communication link, a wide area network (WAN), a local area network (LAN), the Internet, a Virtual Private Network (VPN), an intranet etc. In some arrangements, the communication system 162 can be a wireless communication network 108 as shown in FIG. 1A. In some arrangements, the communication system 162 can be a wired communication network 110 as shown in FIG. 1B.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system comprising:
a processor; and
a memory in communication with the processor, the memory having a path planning module having instructions that, when executed by the processor, cause the processor to:
determine a nominal driving path for a leading vehicle and a following vehicle that follows the leading vehicle,
identify, using sensor data from a sensor system, an obstacle in an external environment that prevents one of the leading vehicle and the following vehicle from utilizing the nominal driving path, wherein the sensor data includes information about the leading vehicle, the following vehicle, and the external environment of the leading vehicle and the following vehicle,
in response to identifying the obstacle, determine an alternate driving path for one of the leading vehicle and the following vehicle that avoids the obstacle, and
operate the leading vehicle and the following vehicle such that one of the leading vehicle and the following vehicle that is prevented from utilizing the nominal driving path due to the obstacle utilizes the alternate driving path and the other utilizes the nominal driving path.

2. The system of claim 1, wherein the path planning module further includes instructions that, when executed by the processor, cause the processor to identify the obstacle that prevents one of the leading vehicle and the following vehicle from utilizing the nominal driving path based on information about the leading vehicle and the following vehicle.

3. The system of claim 2, wherein the information about the leading vehicle and the following vehicle includes at least one of a weight, a height, a length, a width, wheel base dimensions, tire dimensions, a tire pressure, and a steering angle constraints of the leading vehicle and the following vehicle.

4. The system of claim 1, wherein the path planning module further includes instructions that, when executed by the processor, cause the processor to determine the nominal driving path for the leading vehicle and the following vehicle using the sensor data, map data, and the information about the leading vehicle and the following vehicle.

5. The system of claim 1, wherein the alternate driving path merges with the nominal driving path after at least one of the leading vehicle and the following vehicle passes the obstacle.

6. The system of claim 1, wherein the nominal driving path is a driving path to a predetermined location.

7. The system of claim 1, wherein the following vehicle is a hitchless trailer.

8. The system of claim 1, wherein the following vehicle is not physically connected to the leading vehicle.

9. A method comprising the steps of:
determining a nominal driving path for a leading vehicle and a following vehicle that follows the leading vehicle;
identifying, using sensor data from a sensor system, an obstacle in an external environment that prevents one of the leading vehicle and the following vehicle from utilizing the nominal driving path;
in response to identifying the obstacle, determining an alternate driving path for one of the leading vehicle and the following vehicle that avoids the obstacle; and
operating the leading vehicle and the following vehicle such that one of the leading vehicle and the following vehicle that is prevented from utilizing the nominal driving path due to the obstacle utilizes the alternate driving path and the other utilizes the nominal driving path.

10. The method of claim 9, wherein the step of utilizing on information about the leading vehicle and the following vehicle to identify the obstacle that prevents one of the leading vehicle and the following vehicle from utilizing the nominal driving path.

11. The method of claim 10, wherein the information about the leading vehicle and the following vehicle includes at least one of a weight, a height, a length, a width, wheel base dimensions, tire dimensions, a tire pressure, and a steering angle constraints of the leading vehicle and the following vehicle.

12. The method of claim 9, further comprising step of determining the nominal driving path for the leading vehicle and the following vehicle using the sensor data, map data, and information about the leading vehicle and the following vehicle.

13. The method of claim 9, wherein the alternate driving path merges with the nominal driving path after at least one of the leading vehicle and the following vehicle passes the obstacle.

14. The method of claim 9, wherein the nominal driving path is a driving path to a predetermined location.

15. The method of claim 9, wherein the following vehicle is a hitchless trailer.

16. The method of claim 9, wherein the following vehicle is not physically connected to the leading vehicle.

17. A non-transitory computer-readable medium including instructions that, when executed by a processor, cause the processor to:
determine nominal driving path for a leading vehicle and a following vehicle that follows the leading vehicle;
identify, using sensor data from a sensor system, an obstacle in an external environment that prevents one of the leading vehicle and the following vehicle from utilizing the nominal driving path;
in response to identifying the obstacle, determine an alternate driving path for one of the leading vehicle and the following vehicle that avoids the obstacle; and
operate the leading vehicle and the following vehicle such that one of the leading vehicle and the following vehicle that is prevented from utilizing the nominal driving path due to the obstacle utilizes the alternate driving path and the other utilizes the nominal driving path.

18. The non-transitory computer-readable medium of claim 17, further including instructions that, when executed by the processor, cause the processor to identify the obstacle that prevents one of the leading vehicle and the following vehicle from utilizing the nominal driving path based on information about the leading vehicle and the following vehicle.

19. The non-transitory computer-readable medium of claim 18, wherein the information about the leading vehicle and the following vehicle includes at least one of a weight, a height, a length, a width, wheel base dimensions, tire dimensions, a tire pressure, and a steering angle constraints of the leading vehicle and the following vehicle.

20. The method of claim 9, wherein the alternate driving path merges with the nominal driving path after at least one of the leading vehicle and the following vehicle passes the obstacle and the following vehicle is a hitchless trailer.
